(19) United States
(12) Patent Application Publication
(10) Pub. No.: US 2010/0176717 A1
(43) Pub. Date: Jul. 15, 2010

(54) ORGANIC LIGHT EMITTING DISPLAY DEVICE

(75) Inventors: Sun-Young Lee, Yongin-city (KR); Jong-Hyuk Lee, Yogin-city (KR); Yoon-Hyeung Cho, Yongin-city (KR); Min-Ho Oh, Yongin-city (KR); Byoung-Duk Lee, Yongin-city (KR); So-Young Lee, Yongin-city (KR); Kyu-Hwan Hwang, Yongin-city (KR)

Correspondence Address: STEIN MCEWEN, LLP, 1400 EYE STREET, NW, SUITE 300, WASHINGTON, DC, 20005, US

(73) Assignee: Samsung Mobile Display Co., Ltd., Yongin-city (KR)

(21) Appl. No.: 12/537,398

(22) Filed: Aug. 7, 2009

(30) Foreign Application Priority Data
Jan. 12, 2009 (KR) 2009-2241

(51) Int. Cl. H01J 1/62

(52) U.S. Cl. 313/504

(57) ABSTRACT

An organic light emitting display device, comprising: a first insulating layer formed on a substrate; a plurality of patterns formed on the first insulating layer, the patterns and the first insulating layer together forming a surface having a corrugated cross-section; a first electrode formed on the patterns and the first insulating layer, the first electrode having a thickness less than a height of the patterns; an organic light emitting layer formed on the first electrode in a light emitting region; and a second electrode formed on the organic light emitting layer. The light completely reflected by internal surfaces of the first and second electrodes is externally emitted due to a mode mismatch phenomenon in an edge portion of a pattern thereof, thereby increasing a light emission rate of the display device.

### CROSS-REFERENCE TO RELATED APPLICATIONS

This application claims priority to and the benefit of Korean Patent Application No. 2009-2241, filed on Jan. 12, 2009, in the Korean Intellectual Property Office, the content of which is incorporated herein by reference.

### BACKGROUND OF THE INVENTION

1. Field of the Invention

Aspects of the present invention relate to an organic light emitting display device, and more particularly, to an organic light emitting display device that has an improved light emission rate.

2. Description of the Related Art

An organic light emitting display device is the next generation display device and emits light without a backlight. Organic light emitting display devices have excellent viewing angle, contrast, response speed, power consumption, etc., compared to a liquid crystal display device (LCD) so that its application has expanded widely from a personal portable device, such as a cellular phone, to a television (TV).

An organic light emitting display device includes organic light emitters that are coupled between scan lines and data lines in a matrix to form pixels. The organic light emitter includes an anode electrode, an organic light emitting layer, and a cathode electrode, wherein the organic light emitting layer includes a hole injection layer, a hole transport layer, an electron transport layer, and an electron injection layer.

If a voltage difference is applied to the anode electrode and the cathode electrode, holes injected through the anode electrode and electrons injected through the cathode electrode are combined in the organic light emitting layer so that the organic light emitting display device emits light due to the energy difference generated during the process.

At this time, most of the light emitted from the organic light emitting layer is transmitted through at least one of the anode electrode and the cathode electrode to be emitted from the display device; however, light having a specific angle is completely reflected by the anode electrode or the cathode electrode and not emitted from the display device despite one of the anode or cathode electrode being transparent. Therefore, the organic light emitting display device has a low light emission rate.

### SUMMARY OF THE INVENTION

Aspects of the present invention provide an organic light emitting display device that has an improved light emission rate.

Aspects of the present invention provide an organic light emitting display device including: a substrate; a first insulating layer formed on the substrate; a plurality of patterns formed on the first insulating layer, the patterns and the first insulating layer together forming a surface having a corrugated cross-section in at least a portion of a light emitting region; a first electrode formed on the patterns and the first insulating layer, the first electrode having a thickness less than a height of the pattern; a second insulating layer formed on the first electrode and the first insulating layer, the second insulating layer having an opening portion to expose the first electrode in the light emitting region; an organic light emitting layer formed on the first electrode in the light emitting region; and a second electrode formed on the organic light emitting layer.

According to aspects of the present invention, a plurality of patterns is formed on the insulating layer and portions of the organic light emitting layer are formed parallel to the side walls of the patterns. The light emitted from the organic light emitting layer that is completely reflected by the anode electrode and the cathode electrode is changed by edge portions of the patterns so as to be externally emitted so that the light emission rate is more improved compared to the prior art. Aspects of the present invention use the mode mismatch phenomenon, making it possible to arrange the patterns at an interval larger than a wavelength of the light emitted from the organic light emitting layer, having regular or irregular periods, and to enhance the light emission rate for all wavelengths of visible light, including red, green, and blue.

Aspects of the present invention provide an organic light emitting display device, including: a substrate; a first insulating layer formed on the substrate, the first insulating layer having a corrugated cross-section in at least a portion of a light emitting region; a first electrode formed on the first insulating layer; an organic light emitting layer formed on the first electrode in the light emitting region; and a second electrode formed on the organic light emitting layer, wherein the first electrode, the organic light emitting layer, and the second electrode follow the corrugated cross-section of the first insulating layer.

Aspects of the present invention provide an organic light emitting display device, including: a first electrode disposed on a substrate and connected to a thin film transistor formed on the substrate; a second electrode disposed on the first electrode; and an organic light emitting layer disposed between the first and second electrodes; wherein a cross-section of at least a portion of the first electrode, the organic light emitting layer, and the second electrode has a corrugated structure.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view showing an organic light emitting display device according to aspects of the present invention;

FIG. 2 is an exploded cross-sectional view of “A” portion of FIG. 1;

FIG. 3A is a plan view showing an exemplary embodiment of a pattern of FIG. 1;

FIG. 3B is a cross-sectional view taken along line I1-I2 of FIG. 3A;

FIG. 4A is a plan view showing another exemplary embodiment of a pattern of FIG. 1;

FIG. 4B is a cross-sectional view take along line II1-II2 of FIG. 4A;

FIGS. 5A and 5B are cross-sectional views showing intensity of light to be incident and to be emitted;

FIG. 6 is a graph showing light emission rate in a trapezoidal pattern; and

FIG. 7 is a graph showing light emission rate in a hemispheric (wave) pattern.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and descriptions are to be regarded as illustrative in nature and not restrictive. In addition, when an element is referred to as being “disposed on” or “formed on” another element, it can be directly disposed or formed on the other element or be indirectly disposed or formed on the other element with one or more intervening elements disposed therebetween. Also, when an element is referred to as being “connected to” another element, it can be directly connected to the other element or be indirectly connected to the other element with one or more intervening elements disposed therebetween.

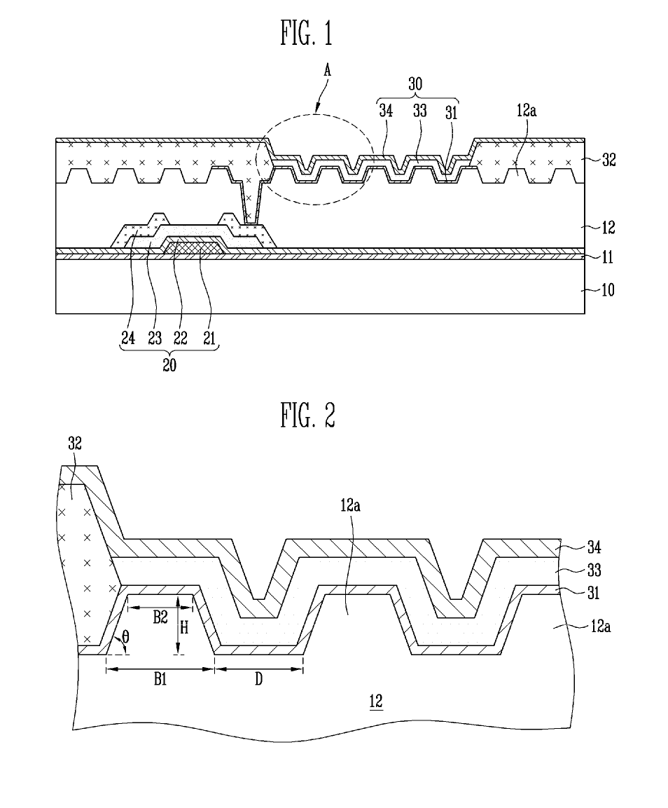

FIG. 1 is a cross-sectional view showing an organic light emitting display device according to aspects of the present invention, and FIG. 2 is an exploded cross-sectional view of the portion “A” of FIG. 1. The organic light emitting display device may include a thin film transistor that controls an operation of an organic light emitter and a capacitor (not shown) that maintains a signal, however only a thin film transistor 20 and an organic light emitter 30 will be described for convenience of explanation.

Referring to FIG. 1, a buffer layer 11 is formed on a substrate 10, and a thin film transistor 20 is formed on the buffer layer 11. The thin film transistor 20 includes a gate electrode 21, a semiconductor layer 23 in which source and drain regions and a channel region are provided, and source and drain electrodes 24 respectively connected to the semiconductor layer 23 at the source and drain regions, wherein the gate electrode 21 is insulated from the semiconductor layer 23 by a gate insulating layer 22. Although the thin film transistor 20 is illustrated as a bottom-gate thin film transistor, aspects of the present invention are not limited thereto such that the thin film transistor 20 may also be embodied as a top-gate thin film transistor.

An insulating layer 12 is formed on the thin film transistor 20 and planarizes the substrate 10 having the thin film transistor 20, and a via hole is formed in the insulating layer 12 to expose the source or drain electrode 24.

Referring to FIGS. 1 and 2, a plurality of patterns 12a are formed in or on the insulating layer 12. In the drawings, the patterns 12a and the insulating layer 12 are formed of the same layer and material, however, the patterns 12a and the insulating layer 12 may be formed of different layers or materials. For example, the pattern 12 may be formed of an organic material such as polyacryl and polyimide, etc., an inorganic material, or mixtures thereof. Further, the patterns 12a may be formed of a multi-layer structure, or having a laminate structure.

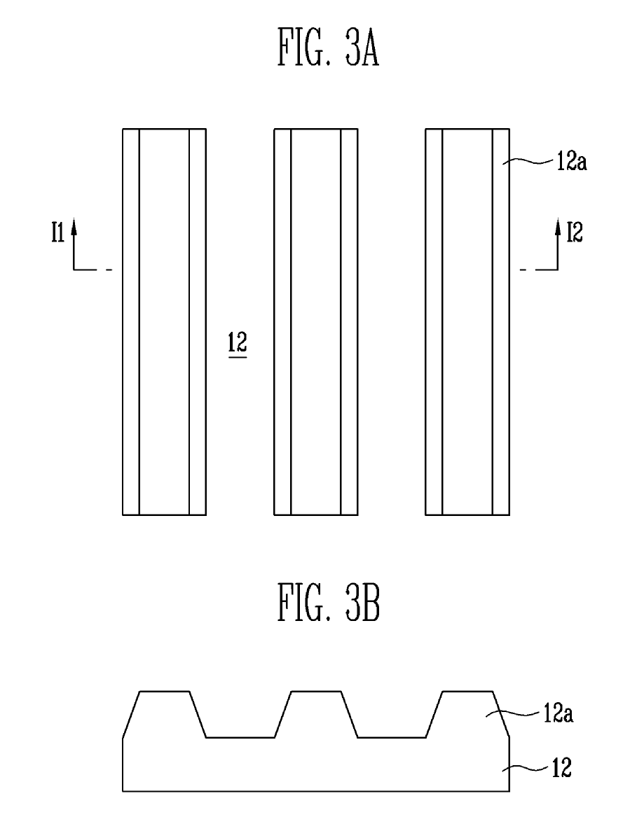

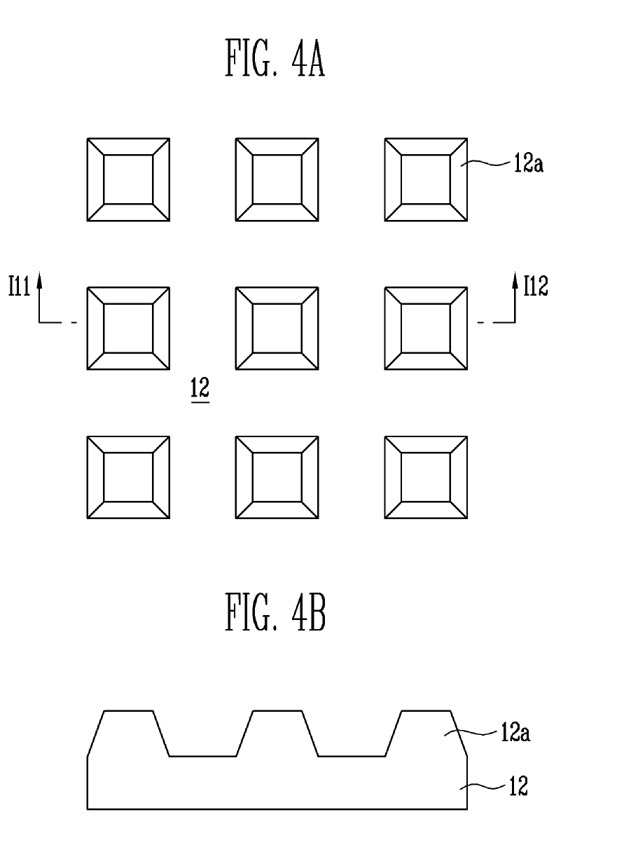

The pattern 12a can have a trapezoidal cross-sectional structure and may be arranged in a stripe form or a dot form. FIGS. 3A and 3B illustrate the patterns 12a arranged in a stripe type, and FIGS. 4A and 4B illustrate the patterns 12a arranged in a dot form. The patterns 12a may be arranged at an interval larger than a wavelength of light emitted from the organic light emitting layer and may be arranged having irregular periods (i.e., having different intervals). Further, the patterns 12a may be extended protrusions resulting in a corrugated structure as shown in FIG. 3A or may be an array of protrusions as shown in FIG. 3B. Further the array of protrusions may be an array of frusta as shown in FIG. 3B. The frusta may be square frusta. Also, the patterns 12a may be formed by adding material to the insulating layer 12 to form the patterns 12a or removing material from the insulating layer 12 to form the patterns 12a. Moreover, the patterns 12a may be formed in or on the entire insulating layer 12 or only in light emitting areas of the insulating layer 12, i.e., portions of the insulating layer 12 on which the anode electrode 31 is disposed and/or exposed through the insulating layer 32.

An anode electrode 31 is formed on the insulating layer 12 including the patterns 12a at a thickness less than a height of the pattern 12a. The anode electrode 31 is coupled to the source or drain electrode 24 of the thin film transistor 20 through the via hole formed on the insulating layer 12. Although described as an anode electrode 31, aspects of the present invention are not limited thereto such that the electrode 31 may be a cathode electrode.

An insulating layer 32 is formed on the insulating layer 12 on which the anode electrode 31 is disposed, and an opening portion is formed in the insulating layer 32 to expose the anode electrode 31 at least in the light emitting region. An organic light emitting layer 33 is formed on the anode electrode 31 in the light emitting region, and a cathode electrode 34 is formed on the insulating layer 32 and the organic light emitting layer 33. The organic light emitting layer 33 includes a hole injection layer, a hole transport layer, an electron transport layer, and an electron injection layer. Although described as a cathode electrode 34, aspects of the present invention are not limited thereto such that the electrode 34 may be an anode electrode.

As described above, a plurality of trapezoidal patterns 12a are formed on the insulating layer 12 and a portion of the organic light emitting layer 33 is formed to be parallel to the side walls of the patterns 12a. In other words, since the anode electrode 31 is formed at a thickness smaller than a height of the pattern 12a, the organic light emitting layer 33 is formed between the patterns 12a, such that the organic light emitting layer 33 may be formed to be parallel to the side walls and surfaces of the patterns 12a.

Therefore, when the light emitted from the organic light emitting layer 33 is completely reflected by the anode electrode 31 and the cathode electrode 34 so as to not be emitted externally therethrough but to be transmitted along and through the light emitting layer 33, the progress of the light is changed by the edge portion of the pattern 12a and emitted externally through the anode electrode 31 or the cathode electrode 34.

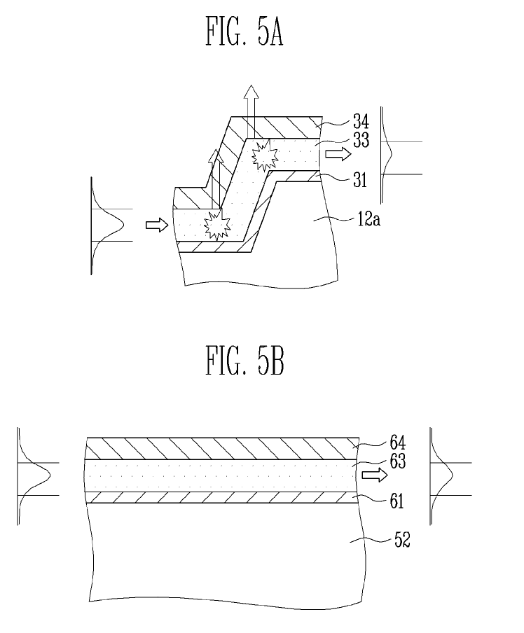

FIG. 5A is a cross-sectional view showing intensity of light completely reflected by the anode electrode 31 and the cathode electrode 31 to be transmitted along and through the light emitting layer 33 (i.e., as opposed to light directly emitted through one of the anode electrode 31 or the cathode electrode 34) and then emitted through one of the anode electrode 31 or the cathode electrode 34 according to aspects of the present invention. FIG. 5B is a cross-sectional view of showing intensity of light completely reflected by an anode electrode 61 and a cathode electrode 64 (disposed on an insulating layer 52 without patterns) to be transmitted along and through a light emitting layer 63 (i.e., as opposed to light directly emitted through one of the anode electrode 61 or the cathode electrode 64).

Referring to FIG. 5A, the intensity of light emitted through or along the length of the light emitting layer 33 is remarkably reduced by the edge portions of the pattern 12a as the light is reflected toward the cathode electrode 34 to be emitted therethrough, i.e., the light emitted from the right side of the light emitting layer 33 of FIG. 5A is substantially reduced. Referring to FIG. 5B, the intensity of light emitted through or along the length of the light emitting layer 63 is not emitted through the cathode electrode 64 and is lost through an end of the light emitting layer, i.e., the intensity of light only slightly decreases as the light is emitted from the right side of the light emitting layer 63 of FIG. 5B is not substantially reduced. Therefore, the light travelling through the light emitting layer 33 according to aspects of the present invention is reflected by the edge portions of the pattern 12a and emitted through one of the cathode electrode 34; while, as shown in FIG. 5B, light travelling through the light emitting layer 63 continues to travel therethrough in a horizontal direction. In other words, owing to a mode mismatch phenomenon of a discontinued position, the progress of light is changed by the edge portion of the pattern 12a to be emitted to external through the cathode electrode 34, thereby reducing the intensity of light emitted in the horizontal direction of FIG. 5A and increasing the intensity of light emitted in the vertical direction of FIG. 5A.

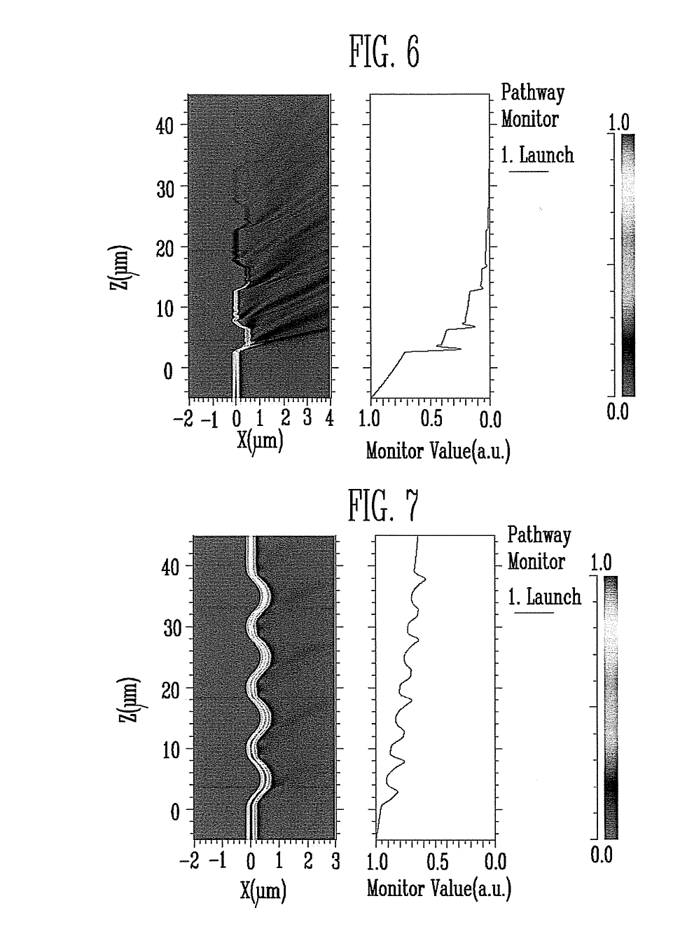

In order to maximize the mode mismatch phenomenon, first, it is preferable that the pattern 12a is formed in a trapezoid shape having edge portions. The trapezoid shape may be an isosceles trapezoid. FIG. 6 is a graph showing light emission rate in the trapezoidal pattern, and FIG. 7 is a graph showing light emission rate in a hemispheric (wave) pattern having no edge portions. The patterns 12a of FIG. 6 and the hemispheric patter of FIG. 7 are formed at a height of 1 μm and an interval of 10 μm. In FIGS. 6 and 7, it can be seen that light transmitted through or along the light emitting layer according to aspects of the present invention (i.e., shown in FIG. 6) is substantially decreased along the Z axis and transmitted through one of the anode or cathode electrodes; while, the light emitted through or along the light emitting layer of a comparative example (i.e., shown in FIG. 7) is not emitted through one of the anode and cathode electrodes so as to continue through the light emitting layer in the direction of the Z axis to be lost at an end of the light emitting layer.

Second, it is preferable that the number of the patterns 12a is increased, if possible, by minimizing the interval D of the patterns 12a (see FIG. 2). Third, it is preferable that both side walls of the patterns 12a have a slope angle (θ) of 35 to 85 degrees by controlling a bottom side B1, a top side B2, and a height H (see FIG. 2). If the slope angle is less than 35 degrees, the light transmission rate through the light emitting layer is high (i.e., the light is not emitted through the cathode electrode 34 but emitted into the insulating layer 32; and, if the slope angle is greater than 85 degrees, it is difficult to form the anode electrode 31 at a predetermined thickness due to defects in covering the edge portions of the patterns 12a.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An organic light emitting display device, comprising:
a substrate;
a first insulating layer formed on the substrate;
a plurality of patterns formed on the first insulating layer, the patterns and the first insulating layer together forming a surface having a corrugated cross-section in at least a portion of a light emitting region;
a first electrode formed on the patterns and the first insulating layer, the first electrode having a thickness less than a height of the patterns;
a second insulating layer formed on the first electrode and the first insulating layer, the second insulating layer having an opening portion to expose the first electrode in the light emitting region;
an organic light emitting layer formed on the first electrode in the light emitting region; and
a second electrode formed on the organic light emitting layer.

2. The organic light emitting display device of claim 1, wherein the corrugated cross-section has a trapezoidal cross-section structure.

3. The organic light emitting display device of claim 2, wherein the corrugated cross-section is arranged in a stripe form that extends to continuously cross at least the light emitting region or a dot form that extends to intermittently cross at least the light emitting region.

4. The organic light emitting display device of claim 1, wherein the corrugated cross-section is corrugated having an interval larger than a wavelength of light emitted from the organic light emitting layer.

5. The organic light emitting display device of claim 4, wherein the corrugated cross-section is corrugated having different intervals.

6. The organic light emitting display device of claim 1, wherein the patterns and the first insulating layer are formed together as a single piece.

7. The organic light emitting display device of claim 1, wherein the patterns are formed having a multi-layer structure.

8. The organic light emitting display device of claim 1, further comprising:
a thin film transistor disposed on the substrate and connected to the first electrode.

9. The organic light emitting display device of claim 1, wherein the height of the corrugations of the corrugated cross-section is about 1 μm.

10. The organic light emitting display device of claim 1, wherein the corrugated cross-section is corrugated having at an interval of about 10 μm.

11. The organic light emitting display device of claim 1, wherein the patterns are an array of frusta disposed on the first insulating layer in at least the light emitting area.

12. The organic light emitting display device of claim 11, wherein the sides of the frusta have slope angles of about 35° to 85° with respect to the substrate.

13. The organic light emitting display device of claim 11, wherein the frusta are square frusta.

14. The organic light emitting display device of claim 2, wherein trapezoidal cross-section structure of the corrugated cross-section has slope angles of about 35° to 85° with respect to the substrate.

15. The organic light emitting display device of claim 1, wherein the cross-section is normal to the substrate.

16. An organic light emitting display device, comprising:
a first electrode disposed on a substrate and connected to a thin film transistor formed on the substrate;
a second electrode disposed on the first electrode; and
an organic light emitting layer disposed between the first and second electrodes;
wherein a cross-section of at least a portion of the first electrode, the organic light emitting layer, and the second electrode has a corrugated structure.

17. The organic light emitting display device of claim 16, wherein the corrugated structure has a trapezoidal cross-section structure.

18. The organic light emitting display device of claim 17, wherein the trapezoidal cross-section structure of the corrugated cross-section has slope angles of about 35° to 85° with respect to the substrate.

19. The organic light emitting display device of claim 16, wherein the cross-section is normal to the substrate.

20. The organic light emitting display device of claim 16, wherein the portion of the first electrode, the organic light emitting layer, and the second electrode is disposed in a light emitting region of the display device.

21. The organic light emitting display device of claim 20, wherein the portion of the first electrode, the organic light emitting layer, and the second electrode extends to continuously cross the light emitting region.

22. The organic light emitting display device of claim 20, wherein the portion of the first electrode, the organic light emitting layer, and the second electrode extends to intermittently cross the light emitting region.

23 The organic light emitting display device of claim 22, wherein the portion comprises an array of frusta.

24. The organic light emitting display device of claim 23, wherein the frusta are square frusta.

25. An organic light emitting display device, comprising:
a substrate;
a first insulating layer formed on the substrate, the first insulating layer having a corrugated cross-section in at least a portion of a light emitting region;
a first electrode formed on the first insulating layer;
an organic light emitting layer formed on the first electrode in the light emitting region; and
a second electrode formed on the organic light emitting layer,
wherein the first electrode, the organic light emitting layer, and the second electrode follow the corrugated cross-section of the first insulating layer.
